(19) United States
(12) Patent Application Publication
(10) Pub. No.: US 2024/0289464 A1
(43) Pub. Date: Aug. 29, 2024

(54) TECHNIQUES FOR THE UNIFICATION OF RAW CYBER DATA COLLECTED FROM DIFFERENT SOURCES FOR VULNERABILITY MANAGEMENT

(71) Applicant: Avalor Technologies, Ltd., Ramat Gan (IL)

(72) Inventors: Kfir Aharon TISHBI, Herzliya (IL); Raanan RAZ, Tel Aviv (IL)

(73) Assignee: Avalor Technologies, Ltd., Ramat Gan (IL)

(21) Appl. No.: 18/176,151

(22) Filed: Feb. 28, 2023

(51) Int. Cl. G06F 21/57

(52) U.S. Cl. CPC G06F 21/577; G06F 2221/034

(57) ABSTRACT

A system and method for unifying cybersecurity data for threat management utilizes a plurality of cybersecurity monitoring systems. The method includes receiving a first cybersecurity signal from a first monitoring system, the first monitoring system configured to monitor a computing environment for a cybersecurity threat; receiving a second cybersecurity signal from a second monitoring system, the second monitoring system configured to monitor the computing environment for the cybersecurity threat, wherein the second monitoring system is independent of the first monitoring system; generating a unified cybersecurity object based on the first cybersecurity signal and the second cybersecurity signal; and determining a severity level of the cybersecurity threat based on the unified cybersecurity object.

### TECHNICAL FIELD

The present disclosure relates generally to cybersecurity, and specifically to generating a unified cybersecurity signal from multiple sources.

### BACKGROUND

Compute systems are ever evolving and changing, in an effort to maximize utility therefrom. Compute resources can be consumed locally, in a cloud computing environment, in hybrid environments, and the like. As such, and with a plethora of services offered on such platforms, organizations have a smorgasbord of choice for various tools, suites, and solutions to most problems they face.

With all this benefit however, comes a challenge. These solutions are distributed across multiple providers, multiple different systems, which are often incompatible. For example, an organization can decide to install both Microsoft® Defender and Norton® Antivirus as malware and virus prevention solutions on user endpoints (e.g., laptops, tablets, and the like devices). In theory, this may provide better coverage, allowing the organization to benefit from the advantages of each solution.

However, there are often areas of overlap, and as a simple example, where the software would detect a threat (e.g., a malware object), both solutions would independently detect the threat, and generate an alert. When multiplied over many solutions and many users in an organization, this leads to a preponderance of alerts, which can cause alert fatigue. Alert fatigue describes a situation where a user who is tasked with deciphering and providing actions responsive of such alerts, simply cannot perform their task due to an overwhelming amount of alerts that need to be delt with.

Furthermore, each system which interacts with a compute environment has a representation of that environment, and as each system interacts differently, no one system has a complete and true view of the compute environment.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for unifying cybersecurity data for threat management. The method also includes receiving a first cybersecurity signal from a first monitoring system, the first monitoring system configured to monitor a computing environment for a cybersecurity threat; receiving a second cybersecurity signal from a second monitoring system, the second monitoring system configured to monitor the computing environment for the cybersecurity threat, where the second monitoring system is independent of the first monitoring system; generating a unified cybersecurity object based on the first cybersecurity signal and the second cybersecurity signal; and determining a severity level of the cybersecurity threat based on the unified cybersecurity object.

Certain embodiments disclosed herein also include a non-transitory computer readable medium having stored thereon instructions for causing a processing circuitry to execute a process. The non-transitory computer readable medium also includes receiving a first cybersecurity signal from a first monitoring system, the first monitoring system configured to monitor a computing environment for a cybersecurity threat; receiving a second cybersecurity signal from a second monitoring system, the second monitoring system configured to monitor the computing environment for the cybersecurity threat, where the second monitoring system is independent of the first monitoring system;

generating a unified cybersecurity object based on the first cybersecurity signal and the second cybersecurity signal; and determining a severity level of the cybersecurity threat based on the unified cybersecurity object.

Certain embodiments disclosed herein also include a system for unifying cybersecurity data for threat management. The system also includes a processing circuitry. The system also includes a memory, the memory containing instructions that, when executed by the processing circuitry, configure the system to: receive a first cybersecurity signal from a first monitoring system, the first monitoring system configured to monitor a computing environment for a cybersecurity threat; receive a second cybersecurity signal from a second monitoring system, the second monitoring system configured to monitor the computing environment for the cybersecurity threat, where the second monitoring system is independent of the first monitoring system; generate a unified cybersecurity object based on the first cybersecurity signal and the second cybersecurity signal; and determine a severity level of the cybersecurity threat based on the unified cybersecurity object.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram of a compute environment monitored by a plurality of cybersecurity monitoring solutions, utilized to describe an embodiment.

FIG. 2 is an example graph representing a compute environment from a plurality of sources, implemented in accordance with an embodiment.

FIG. 3 is an example schematic illustration of an uber node of a representation graph, implemented according to an embodiment.

FIG. 4 is an example flowchart of a method for generating a unified cybersecurity object, implemented according to an embodiment.

FIG. 5 is an example of a flowchart of a method for representing tickets of a cybersecurity ticketing system, implemented in accordance with an embodiment.

FIG. 6 is an example flowchart of a method for maintaining digital asset status, implemented in accordance with an embodiment.

FIG. 7 is an example flowchart of a method for initiating monitoring of a compute environment based on a scan result from another monitoring solution, implemented in accordance with an embodiment.

FIG. 8 is an example schematic diagram of a mapper according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for unifying cybersecurity data for threat management utilizes a plurality of cybersecurity monitoring systems. In an embodiment, each cybersecurity monitoring system provides data from various scanners, such that a first scanner from a first cybersecurity system, and a second scanner from a second cybersecurity system, both provide data related to, for example, a resource deployed in a cloud computing environment.

In an embodiment, a cybersecurity threat is detected from the first scanner, and not detected by the second cybersecurity monitoring system. In some embodiments, the second cybersecurity monitoring system to scan the resource for the cybersecurity threat, in response to detecting the cybersecurity threat by the first scanner.

In some embodiments, a cybersecurity threat is detected on a resource at a first time. The resource, the cybersecurity threat, a combination thereof, and the like, is stored on a representation graph. In an embodiment, a representation is evicted from the representation graph after a period of time has lapsed. In certain embodiments, the representation is evicted from the representation graph in response to detecting that the cybersecurity is not detected in a data scan received from a cybersecurity monitoring system at a second time, which is after the first time.

In this regard, it is recognized that a human can initiate storing information related to resources, and can receive such information from multiple sources. However, a human is not capable of receiving an amount of information a single scanner is configured to provide from a cloud computing environment having hundreds of resources, principals, and the like, let alone from a plurality of scanners, let alone from a plurality of scanners of different cybersecurity monitoring solutions.

Even if a human were capable somehow of receiving such data, it would be impossible to cross-reference all the data to detect scan data related to the same resource from a plurality of different cybersecurity monitoring systems, and generate a unified entity that is updated continuously each time new scan data is received.

A human is incapable of performing such cross-references, at least because doing so requires applying rules for matching, for example, in a manner that is consistent and objective, which is something a human mind is simply not equipped to do. The system disclosed herein solves at least this by applying matching rules in a manner that is consistent, using objective criteria, for example when determining that data received from different scanners relates to the same resource in a cloud computing environment.

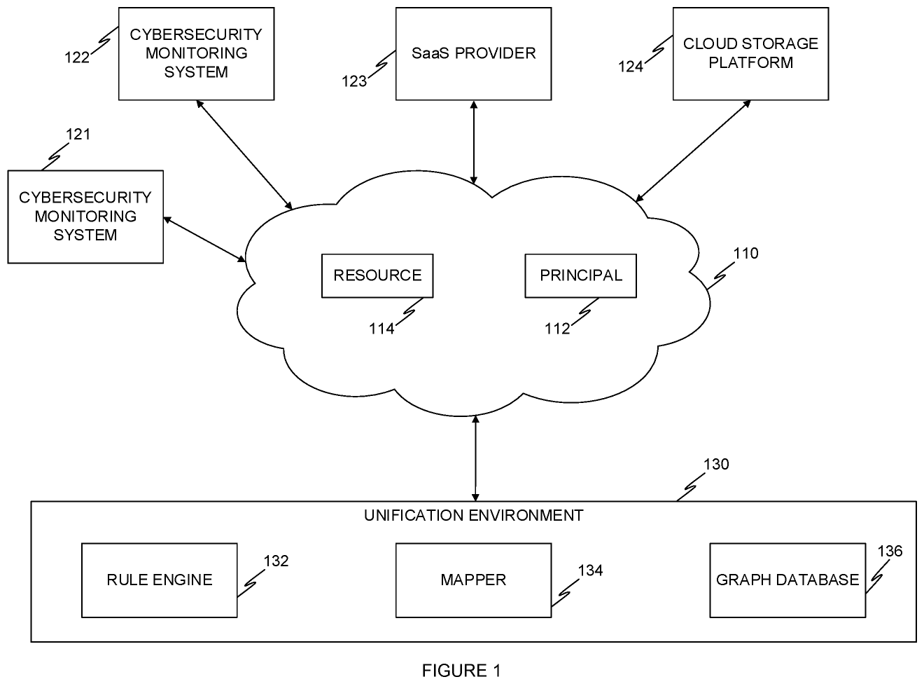

FIG. 1 is an example network diagram of a compute environment monitored by a plurality of cybersecurity monitoring solutions, utilized to describe an embodiment. In an embodiment, the computing environment 110 is a cloud computing environment, a local computing environment, a hybrid computing environment, and the like. For example, in some embodiments, a cloud computing environment is implemented on a cloud computing infrastructure. For example, the cloud computing environment is a virtual private cloud (VPC) implemented on Amazon® Web Services (AWS), a virtual network (VNet) implemented on Microsoft® Azure, and the like.

In an embodiment, the cloud computing environment includes multiple environments of an organization. For example, a cloud computing environment includes, according to an embodiment, a production environment, a staging environment, a testing environment, and the like.

In certain embodiments, the computing environment 110 includes entities, such as resource and principals. A resource 114 is, for example, a hardware resource, a software resource, a computer, a server, a virtual machine, a serverless function, a software container, an asset, a combination thereof, and the like. In an embodiment, a resource 114 exposes a hardware resource, provides a service, provides access to a service, a combination thereof, and the like.

In some embodiments, a principal 112 is authorized to act on a resource 114. For example, in a cloud computing environment, a principal 112 is authorized to initiate actions in the cloud computing environment, act on the resource 114, and the like. A principal is, according to an embodiment, a user account, a service account, a role, and the like. In some embodiments, a resource 114 is deployed in a production environment, and another resource (not shown) which corresponds to the resource 114 is deployed in a staging environment. This is utilized, for example, when testing the performance of a resource in an environment which is similar to the production environment. Having multiple compute environments, where each environment corresponds to at least another compute environment, is a principal of software development and deployment known as continuous integration/continuous deployment (CI/CD).

In an embodiment, the computing environment 110 is communicatively coupled with a first cybersecurity monitoring system 121, a second cybersecurity monitoring system 122, a SaaS provider 123, a cloud storage platform 124, and the like. A cybersecurity monitoring system includes, for example, scanners and the like, configured to monitor a compute environment for cybersecurity threats such as malware, exposures, vulnerabilities, misconfigurations, and the like. In some embodiments, having multiple cybersecurity monitoring systems is advantageous, as each cybersecurity monitoring system may be configured to provide different capabilities, such as scanning for different types of cybersecurity threats.

According to some embodiments, each of the first cybersecurity monitoring system 121, the second cybersecurity monitoring system 122, the SaaS provider 123, the cloud storage platform 124, and the like, are configured to interact with the compute environment 110. For example, the cybersecurity monitoring systems (121 and 122) are configured to monitor assets, such as resources, of the computing environment 110. Each system which interacts with the computing environment 110 has data, metadata, and the like, which the system utilizes for interacting with the computing environment 110.

For example, a cybersecurity monitoring system is configured to store a representation of the computing environment, for example as a data model which includes detected cybersecurity threats. Such a representation, model, and the like, is a source, for example for modeling the compute environment 110. In some embodiments, a source provides data, for example as a data stream, including records, events, and the like. For example, a data stream includes, according to an embodiment, a record of a change to the compute environment, an event indicating detection of the change, communication between resources, communication between a principal and a resource, communication between principals, combinations thereof, and the like.

In an embodiment, a SaaS provider 123 is implemented as a computing environment which provides software as a service, for example a client relationship management (CRM) software, a sales management software (e.g., Salesforce®), and the like.

In some embodiments, a cloud storage platform 124 is implemented as a cloud computing environment which provides a service to the compute environment. For example, in certain embodiments, the cloud storage platform 124 is a storage service, such as Amazon® Simple Storage Solution (S3).

In an embodiment, a unification environment 130 is communicatively coupled with the compute environment 110. In certain embodiments, the unification environment 130 is configured to receive data from a plurality of sources, such as the cloud storage platform 124, the SaaS provider 123, and the cybersecurity monitoring systems 122 and 121.

According to an embodiment, the unification environment 130 includes a rule engine 132, a mapper 134, and a graph database 136. In some embodiments, a rule engine 132 is deployed on a virtual machine, software container, serverless function, combination thereof, and the like. In an embodiment, the mapper 134 is configured to receive data from a plurality of sources, and store the data based on at least a predefined data structure (e.g., of a graph) in the graph database 136. A graph database 136 is, in an embodiment, Neo4j®, for example. In some embodiments, the predefined data structure includes a plurality of data fields, each data field configured to store at least a data value.

In certain embodiments, the data structure is a dynamic data structure. A dynamic structure is a data structure which changes based on an input. For example, in certain embodiments a source provides a data field which is not part of the predefined data structure of a graph stored in the graph database 136. In such embodiments, the mapper 134 is configured to redefine the predefined data structure to include the data field which was not previously part of the predefined data structure.

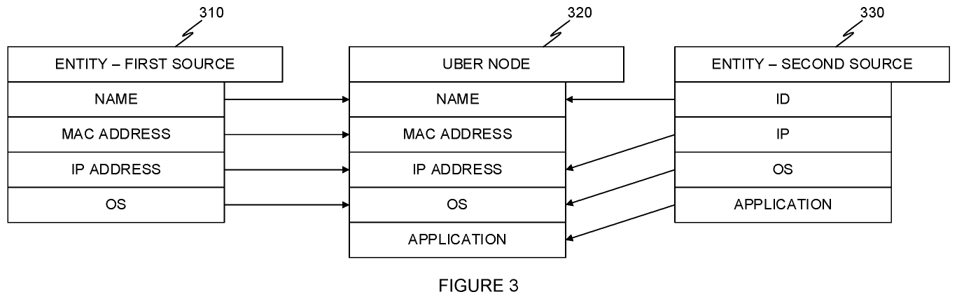

In some embodiments, the mapper 134 is configured to map a data field of a first source and a data field of a second source to a single data field of the predefined data structure. An example of such mapping is discussed in more detail with respect to FIG. 3 below. In certain embodiments, the mapper 134 is configured to store a mapping table which indicates, for each data source, a mapping between a data field of the source and a data field of a predefined data structure of the graph stored in the graph database 136.

The graph database 136 is configured to store a representation of data from a plurality of data sources, each data source representing, interacting with, and the like, the compute environment 110, according to an embodiment. For example, in some embodiments, the graph database 136 is configured to store a representation of principals, resources, events, enrichments, and the like.

In some embodiments, the mapper 134 is configured to utilize a rule engine 132 to determine which data field from a first source is mapped to a data field of the predefined data structure. In certain embodiments, the rule engine 132 includes a rule which is utilized by the mapper 134 to determine what data to store in a data conflict event. In some embodiments the rule engine 132 is configured to store a rule, a policy, combinations thereof, and the like. In certain embodiments, the rule engine 132 is a multi-tenant rule engine, serving a plurality of compute environment 110. In such embodiments, the rule engine 132 is configured to apply rules per tenant. For example, a first tenant utilizes a first source mapped using a first mapping, while a second tenant utilizes the first source mapped using a second mapping.

In certain embodiments, the rule engine 132 includes a control. A control is a rule, condition, and the like, which is applied to an entity of the compute environment 110. An entity is, for example, a principal, a resource, an event, and the like, according to an embodiment. In some embodiments, the control is implemented using a logic expression, such as a Boolean logic expression. For example, in an embodiment, a control includes an expression such as “NO ‘Virtual Machine’ HAVING ‘Operating System’ EQUAL ‘Windows 7’”. In some embodiments, the rule engine 132 is configured to traverse the graph stored in the graph database 136 to determine if a representation stored thereon violates a control.

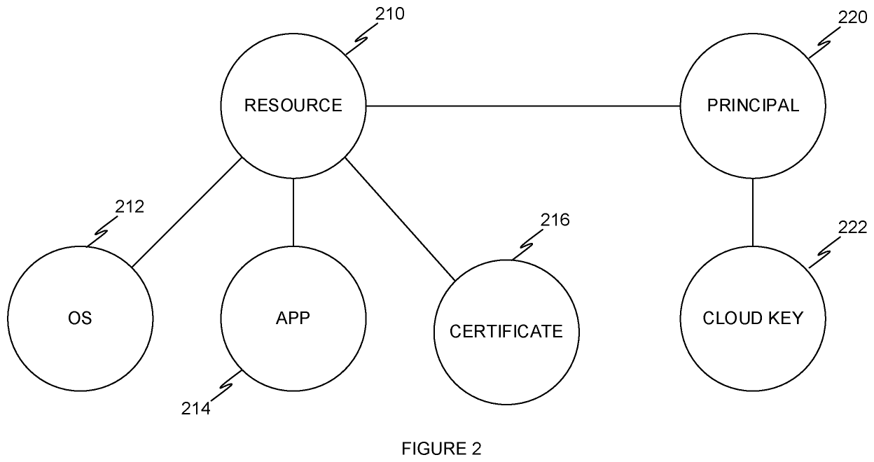

FIG. 2 is an example graph representing a compute environment from a plurality of sources, implemented in accordance with an embodiment. In an embodiment, a compute environment is monitored by a plurality of cybersecurity monitoring solutions. For example, in an embodiment a cloud computing environment is monitored by a first cybersecurity monitoring solution (e.g., Snyk®), and a second cybersecurity monitoring solution (e.g., Rapid7®). The plurality of cybersecurity monitoring solutions differ from each other, for example by monitoring for different cybersecurity threats, monitoring different assets, monitoring different principals, monitoring different data fields, storing different data, and the like. For example, in an embodiment a first cybersecurity monitoring solution is configured to store a unique identifier of a resource under an “ID” data field, whereas a second cybersecurity monitoring solution is configured to store a unique identifier of the same resource as “Name”. Respective of a unification environment, each cybersecurity monitoring solution is a source of the compute environment.

In some embodiments, it is therefore beneficial to utilize a single data structure to store data from multiple sources. In some embodiments, the data structure includes a metadata indicator to indicate an identifier of the source for a certain data field. In some embodiments, the data structure includes a metadata indicator to indicate that a data field value is cross-referenced between a plurality of sources. A metadata indicator is configured to receive a value, according to an embodiment, which corresponds to a predetermined status.

In an embodiment, a resource is represented by a resource node 210. A resource is, for example, a physical machine, a virtual machine, a software container, a serverless function, a software application, a platform as a service, a software as a service, an infrastructure as a service, and the like. In an embodiment, a resource node includes a data structure which is selected for the resource node based on a resource type indicator. For example, in an embodiment a first resource is a virtual machine for which a resource node is stored based on a first resource type, and a second resource is an application for which a resource node is stored based on a second resource type.

The resource node 210 is connected (e.g., via a vertex) to a principal node 220, an OS node 212, an application node 214, and a certificate node 216. In an embodiment, a vertex further indicates a relationship between the represented nodes. For example, a vertex connecting a resource node 210 to a principal node 220 indicates, according to an embodiment, that the principal represented by the principal node 220 can access the resource represented by the resource node 210. In an embodiment, the principal node 220 represents a principal, such as a user account, a service account, a role, and the like.

In an embodiment, a first cybersecurity monitoring solution detects a resource in a compute environment, and scans the resource to detect an operating system (OS). The resource is represented by the resource node 210, the operating system is represented by the OS node 212, and a vertex is generated between the resource node 210 and the OS node 212 to indicate that the OS is deployed on the resource. A second cybersecurity monitoring solution detects the resource in the compute environment, and further detects an application executed on the OS of the resource. The application is represented in the graph by the application node 214, and connected to the resource node 212. As the first cybersecurity monitoring solution already detected the resource, there is no need to duplicate the data and generate another representation of the resource based on the second cybersecurity monitoring solution. Instead, any data differences are stored in the resource node 210 representing the resource.

In some embodiments, a cybersecurity monitoring solution is further configured to scan the contents of a disk of the resource, and detect cybersecurity objects, such as an encryption key, a cloud key, a certificate, a file, a folder, an executable code, a malware, a vulnerability, a misconfiguration, an exposure, and the like. For example, in an embodiment, the second cybersecurity monitoring solution is further configured to scan the resource and detect a certificate, represented by certificate node 216.

In an embodiment, a source for a unification environment is an identity and access management (IAM) service. In some embodiments, an IAM service includes a rule, a policy, and the like, which specify an action a principal is allowed to initiate, an action which a principal is not allowed to initiate, combinations thereof, and the like.

In some embodiments, an IAM service is queried to detect an identifier of a principal. The principal is represented in the graph by principal node 220, and is, according to an embodiment, a user account, a service account, a role, and the like. In an embodiment, the IAM service is further queried to detect an identifier of a key, an identifier of a policy, and the like, which are associated with a principal. For example, in an embodiment, a cloud key which is assigned to a principal represented by the principal node 220, is represented by a cloud key node 222. In an embodiment, the cloud key represented by the cloud key node 222 allows the principal represented by the principal node 220 to access the resource represented by the resource node 210.

In some embodiments, a resource is represented by a plurality of resource nodes, each resource node corresponding to a unique data source. In such embodiments, it is useful to generate an uber node which is connected to each node which represents the resource. In an embodiment, generating an uber node and storing the uber node in the graph allows to generate a compact view of assets of a compute environment, while allowing traceability of the data to each source. An example embodiment of such a representation is discussed in more detail with respect to FIG. 3 below.

FIG. 3 is an example schematic illustration of an uber node of a representation graph, implemented according to an embodiment. In an embodiment, a mapper is configured to receive data from multiple sources, detect an entity represented by a plurality of sources, and map data fields from each source to a data field of an uber node which represents the entity in a graph data structure. For example, a first entity 310 is represented by a first source using a first data schema, and a second entity 330 is represented by a second source using a second data schema, in an embodiment. In certain embodiments, the first source is, for example, a SaaS solution provided by Servicenow®, and the second source is, for example, a SaaS solution provided by Rapid7. Each source interacts with a compute environment, the resources therein, the principals therein, and the like, in a different manner, using different methods, and store data utilizing different data structures, in accordance with an embodiment.

In an embodiment, the first entity 310 includes a first plurality of data fields, such as ‘name’, ‘MAC address’, ‘IP address’, and ‘OS’. In some embodiments, the second entity 330 includes a second plurality of data fields, such as ‘ID’, ‘IP’, ‘OS’, and ‘Application’. In certain embodiments, a mapper is configured to detect values of data fields which match the first entity 310 to the second entity 330. In some embodiments, the mapper is further configured to map the data fields of each of the sources to a data field of an uber node 320, which is a representation of an entity based on a plurality of different sources.

For example, in an embodiment the data field ‘Name’ of the first entity 310, and the data field ‘ID’ of the second entity 330, are mapped to the data field ‘Name’ of the uber node 330. In some embodiments, a mapper is configured to utilize a rule engine to match a first entity to a second entity and generate therefrom an uber node. For example, in an embodiment, a first entity 310 is matched to a second entity 320 based on a rule stipulating that a value of the data field ‘Name’ from a first source should match a value of the data field ‘ID’ of a second source. In some embodiments, a plurality of values from a first source are matched to a plurality of values from a second source, in determining that a first entity matches a second entity. For example, in an embodiment a plurality of values correspond to a unique identifier (e.g., ‘name’, ‘ID’, and the like) coupled with an IP address.

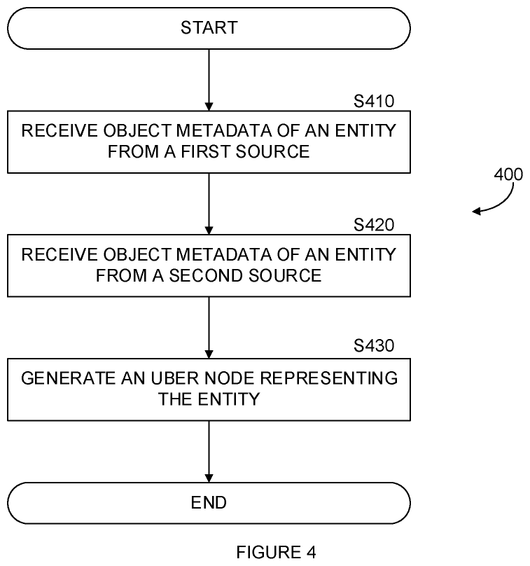

FIG. 4 is an example flowchart of a method for generating a unified cybersecurity object, implemented according to an embodiment.

At S410, metadata is received from a first source. In an embodiment, the metadata describes a data structure of a first entity of a compute environment. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In some embodiments, a source is an IAM service, a SaaS connected to the compute environment, a PaaS connected to the compute environment, an IaaS connected to the compute environment, a cybersecurity monitoring solution, a ticketing system, a data lake, a business intelligence (BI) system, a customer relationship management (CRM) software, an electronic management system (EMS), a warehouse management system, and the like. According to an embodiment, a source is a computing environment, such as a cloud computing environment, which interacts with, monitors, and the like, the compute environment in which the first entity is deployed.

In an embodiment, the first entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

At S420, metadata is received from a second source. In an embodiment, the metadata describes a data structure of a second entity of the compute environment from a second source, which is not the first source. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In some embodiments, a source is an IAM service, a SaaS connected to the compute environment, a PaaS connected to the compute environment, an IaaS connected to the compute environment, a cybersecurity monitoring solution, a ticketing system, a data lake, a business intelligence (BI) system, a customer relationship management (CRM) software, an electronic management system (EMS), a warehouse management system, and the like. According to an embodiment, a source is a computing environment, such as a cloud computing environment, which interacts with, monitors, and the like, the compute environment in which the second entity is deployed. In an embodiment, the first source and the second source are different sources of the same type. For example, AWS Identity and Access Management and Okta® provide two solutions (i.e., sources) of the same type (i.e., identity and access management services) from different sources.

In an embodiment, the second entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

At S430, an uber node is generated. In an embodiment, an uber node is generated based on a predefined data structure to represent the entity. In some embodiments, the predefined data structure is a dynamic data structure. In an embodiment, a dynamic data structure includes an initial data structure which is adaptable based on data fields received from various sources. For example, in an embodiment, a data field is detected from a first source which is not mappable to an existing data field in the predefined data structure. In such an embodiment, the detected data field is added to the predefined data structure, and the value of the detected data field is stored based on the adapted predefined data structure.

In certain embodiments, the uber node is generated based on a determination that the first entity from the first source and the second entity from the second source are a single entity on which data is received from both the first source and the second source. For example, in an embodiment a match is performed between a predefined data field, a plurality of predefined data fields, and the like, to determine, for example by generating a comparison, if a value of a data field of the first entity matches a value of a corresponding data field of the second entity (e.g., same IP address, same MAC address, same unique identifier, etc.).

In some embodiments, the uber node is generated in a graph which further includes a representation of the compute environment, a representation of the first source, a representation of the second source, combinations thereof, and the like. In certain embodiments, a first node is generated in the graph to represent the first entity, and a second node is generated in the graph to represent the second entity. According to an embodiment, a connection is generated between each of the first node and the second node with the uber node.

In an embodiment, the uber node represents a cloud entity, such as a principal, a resource, an enrichment, and the like. In some embodiments, the uber node represents a cybersecurity object, such as a cybersecurity threat (e.g., a malware code, a malware object, a misconfiguration, a vulnerability, an exposure, and the like), a cloud key, a certificate, and the like. In certain embodiments, the uber node represents a ticket, for example generated from a Jira® ticketing system.

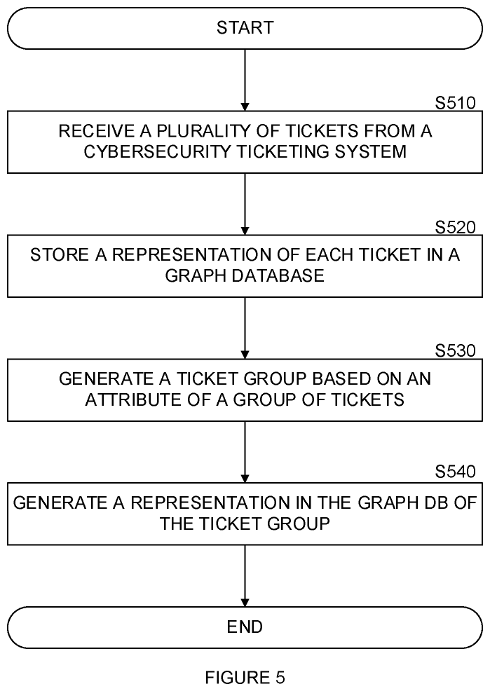

FIG. 5 is an example of a flowchart 500 of a method for representing tickets of a cybersecurity ticketing system, implemented in accordance with an embodiment. A cybersecurity ticketing system is a ticketing system which generates tickets based on alerts received from cybersecurity monitoring solutions.

At S510, a plurality of tickets are received. In an embodiment, each ticket of the plurality of tickets is generated based on an alert from a cybersecurity monitoring solution. In some embodiments, a ticket is generated based on a unique alert. In certain embodiments a ticket is generated based on a plurality of unique alerts. In some embodiments, a plurality of tickets are generated based on a single alert. In an embodiment, an alert includes an identifier of a cybersecurity issue, an identifier of a resource on which the cybersecurity issue was detected, a timestamp, an identifier of a computing environment in which the resource is deployed, a combination thereof, and the like.

In certain embodiments, a ticket generated based on an alert includes an identifier of a cybersecurity issue, an identifier of a resource on which the cybersecurity issue was detected, a timestamp, an identifier of a computing environment in which the resource is deployed, a ticket status indicator, a combination thereof, and the like. In an embodiment, a ticket status indicator includes a value, such as open, resolved, closed, and the like.

At S520, a representation of each ticket of the plurality of tickets is stored in a graph database. In certain embodiments, storing a ticket in a graph database includes generating a node in the graph which represents the ticket. In an embodiment, the representation for each ticket is a node in the graph. In certain embodiments, storing the representation (i.e., node) in the graph includes storing ticket data associated with the node. For example, ticket data such as a view indicator, an identifier of a cybersecurity issue, an identifier of a resource on which the cybersecurity issue was detected, a timestamp, an identifier of a computing environment in which the resource is deployed, a ticket status indicator, a combination thereof, and the like, is stored in the graph database.

At S530, a ticket group is generated based on a shared attribute of a group of tickets. In certain embodiments, a ticket group is generated based on clustering techniques. A clustering technique is, according to an embodiment, a K-means clustering, DBSCAN clustering, Gaussian Mixture Model clustering, BIRCH clustering, spectral clustering, and the like. In an embodiment a plurality of values of an attribute are extracted from a plurality of tickets. In certain embodiments, tickets are clustered based on the extracted plurality of values. In some embodiments, a threshold is used to determine if a value of an attribute of a ticket should be clustered into a first group, a second group, and the like. For example, in an embodiment, software versions having a value between ‘1.1’ and ‘2.3’ are clustered into a first group, software versions having a value between ‘2.4’ and ‘3.2’ are clustered into a second group, etc.

In some embodiments, a ticket group is generated by applying a rule from a rule engine on a plurality of tickets. In an embodiment, a ticket group represents a group of tickets, having at least one attribute value in common. An attribute is, in an embodiment, a type of resource, an identifier of a cybersecurity issue, an identifier of an application, and the like. For example, a value of a type of resource is a virtual machine, a software container, a serverless function, and the like. A value of an attribute such as an identifier of a cybersecurity issue is, for example, a unique CVE identifier.

In an embodiment, a shared attribute is an application vulnerability of a specific application. For example, the application is Google® Chrome® web browser having any vulnerability. As another example, the shared attribute is a node of a repository, such as GitHub®. When used to group tickets, this attribute groups all tickets representing a vulnerability originating directly from the node of the repository, originating from a library to which the node has a dependency of, and the like.

At S540, a representation of the ticket group is generated in the graph database. In an embodiment, the representation for the ticket group is a group node in the graph, the group node connected to a plurality of nodes, each representing a unique ticket which comprises the ticket group. In certain embodiments, storing the representation (i.e., node) in the graph includes storing ticket data associated with the node. For example, ticket data such as a view indicator, an identifier of a cybersecurity issue, an identifier of a resource on which the cybersecurity issue was detected, a timestamp, an identifier of a computing environment in which the resource is deployed, a ticket status indicator, a combination thereof, and the like, is stored in the graph database.

In an embodiment, a view indicator receives a numerical value. For example, in an embodiment a base view (i.e., a view having the least number of tickets) includes all tickets, ticket groups, and the like, having a view value of ‘0’. For example, ticket group nodes, and ticket nodes not connected to a ticket group node, receive a view value of ‘0’ in an embodiment. Ticket nodes which are connected to a ticket group node receive a value of ‘1’. Where a request is received to generate a view on a display with a view value of ‘1’ or lower, are visually represented on the display.

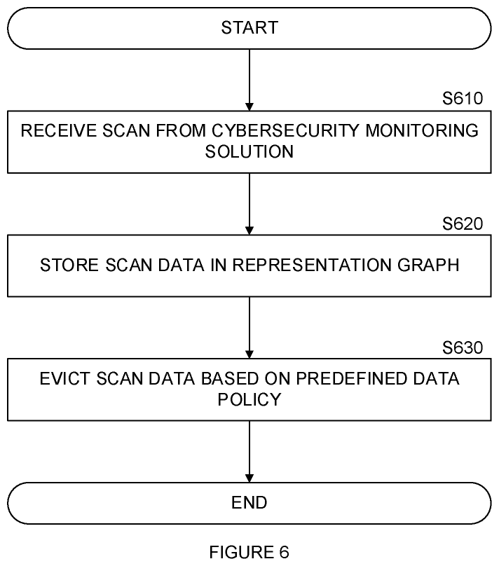

FIG. 6 is an example flowchart of a method for maintaining digital asset status, implemented in accordance with an embodiment.

At S610, a scan is received from a cybersecurity monitoring solution. In an embodiment, the scan includes data generated from a first cybersecurity monitoring solution at a first time, data generated from a second cybersecurity monitoring solution at the first time, a combination thereof and the like.

In an embodiment, a scan includes an identifiers of a resource, an identifier of a principal, a risk detected on a resource, a risk associated with a principal, an identifier of a ticket, a combination thereof, and the like.

In some embodiments, a scan is received as a full scan, an incremental scan, a partial scan, a combination thereof, and the like. For example, in an embodiment, a combination of a scan includes a full scan received from a first cybersecurity monitoring solution at a first time, and a partial scan received from a second cybersecurity monitoring solution at the first time.

In an embodiment, a full scan maintains a consistent state of all principals, resources, vulnerabilities, misconfigurations, exposures, tickets, and the like, that exist in the computing environment. In certain embodiments, an incremental scan is provided by a cybersecurity monitoring solution which maintains a full list of all entities in the computing environment, and further includes a log having a record corresponding to each change that occurred over time, allowing to retrieve changed entities after a specific point in time. In an embodiment, a partial scan includes information about entities encountered on the last scan. Therefore, if a resource was unreachable at the last scan, for example, this specific resource will not exist in the data we retrieved from the scanner. This does not mean necessarily that a cybersecurity issue was resolved. It is therefore beneficial to maintain a state from a partial scan over time, which allows to determine for various entities what their state is.

At S620, the scan data is stored in a representation graph. In an embodiment, the scan data is stored for a predetermined amount of time. For example, in an embodiment, a first scan data received at a first time includes an identifier of a resource having a cybersecurity threat. According to an embodiment, a second scan data received at a second time does not include the identifier of the resource. In some embodiments, the identifier of the resource having the cybersecurity threat is stored for a predefined period of time, for a predefined number of received scans, a combination thereof, and the like.

At S630, scan data is evicted. In an embodiment, scan data is evicted based on an eviction policy. In some embodiments, the eviction policy includes a condition whereby a full scan indicates that a ticket is resolved, a cybersecurity threat is mitigated, and the like. For example, in an embodiment, a plurality of scan data are received, each at a different time. In an embodiment, where the plurality of scan data exceeds a predefined threshold (e.g., four times scan data is received from the same cybersecurity monitoring solution), the identifier of the resource having the cybersecurity threat is deleted, removed, and the like, from the representation graph.

In an embodiment, a first scan data is received at a first time indicating that a first resource includes a cybersecurity threat. The scan data is stored in the representation graph, according to an embodiment. For example, in an embodiment, the first resource, the cybersecurity threat, and the like, are represented in the representation graph. In an embodiment, a second scan data is received at a second time, indicating that the first resource does not include the cybersecurity threat.

In certain embodiments, the representation of the cybersecurity threat is evicted (e.g., deleted, removed, etc.) from the representation graph in response to detecting that the cybersecurity threat is not detected in the second scan data. In some embodiments, the second scan data and the first scan data are each a full scan.

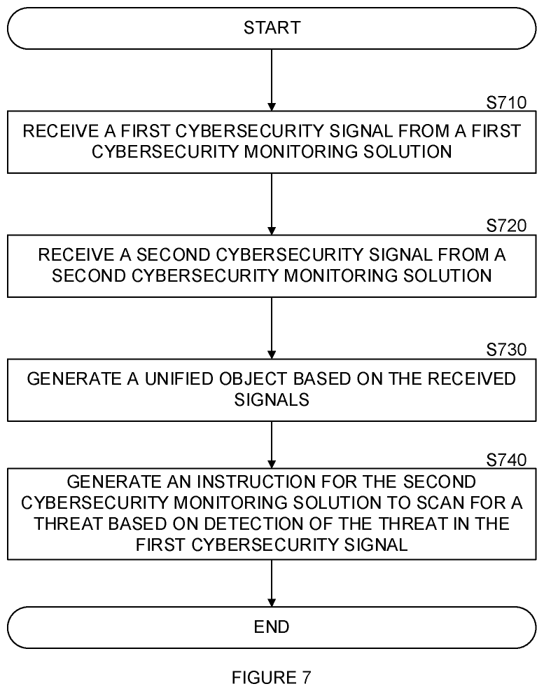

FIG. 7 is an example flowchart of a method for initiating monitoring of a compute environment based on a scan result from another monitoring solution, implemented in accordance with an embodiment.

At S710, a first cybersecurity signal is received. In an embodiment, the first cybersecurity signal is received from a first cybersecurity monitoring system, configured to monitor a computing environment for a cybersecurity threat.

For example, in an embodiment, the cybersecurity threat is detected based on a cybersecurity object. A cybersecurity object is, according to an embodiment, a secret, a certificate, a misconfiguration, user account data, and the like. In an embodiment, the first cybersecurity signal includes scan data from a scanner of the first cybersecurity monitoring solution.

At S720, a second cybersecurity signal is received. In an embodiment, the second cybersecurity signal is received from a second monitoring system, configured to monitor the computing environment for a cybersecurity threat. In certain embodiments, the second monitoring system is independent of the first monitoring system. In certain embodiments, scan data of the second cybersecurity signal includes a cybersecurity object, a cybersecurity threat, and the like, which are not detected in corresponding scan data of the first cybersecurity signal. This can be, for example, due to differences in scanning capabilities between two cybersecurity monitoring solutions, differences in access times, differences in access capabilities, and the like.

For example, in an embodiment a first cybersecurity monitoring system detects a cybersecurity threat on a resource at a first time, while a second cybersecurity monitoring system does not detect the cybersecurity threat on the resource at the first time.

At S730, a unified cybersecurity object is generated. In an embodiment, the unified cybersecurity object is generated based on the first cybersecurity signal and the second cybersecurity signal. An example of generating a unified cybersecurity object is discussed in more detail with respect to FIG. 4 above.

An advantage of having a unified cybersecurity object is having a complete picture of all entities, risks, threats, tickets, and the like, associated with a computing environment.

At S740, an instruction is generated to scan for the cybersecurity threat. In an embodiment, the cybersecurity threat is detected in the first signal, and not detected in the second signal. In such an embodiment, an instruction is generated which when executed by the second cybersecurity monitoring solution, configures the second cybersecurity monitoring solution to initiate a scan of the resource, the computing environment, a combination thereof, and the like, for the cybersecurity threat detected by the first cybersecurity monitoring system.

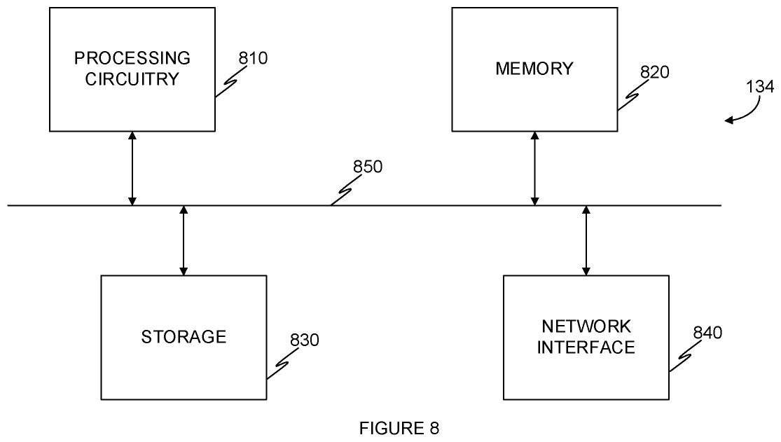

FIG. 8 is an example schematic diagram of a mapper 134 according to an embodiment. The mapper 134 includes a processing circuitry 810 coupled to a memory 820, a storage 830, and a network interface 840. In an embodiment, the components of the mapper 134 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof. In an embodiment, the memory 820 is an on-chip memory, an off-chip memory, a combination thereof, and the like. In certain embodiments, the memory 820 is a scratch-pad memory for the processing circuitry 810.

In one configuration, software for implementing one or more embodiments disclosed herein may be stored in the storage 830, in the memory 820, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 840 is configured to provide the mapper 134 with communication with, for example, the rule engine 132.

It should be understood that the embodiments described herein are not limited to the specific architecture illustrated in FIG. 8, and other architectures may be equally used without departing from the scope of the disclosed embodiments.

Furthermore, in certain embodiments the rule engine 132 may be implemented with the architecture illustrated in FIG. 8. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for unifying cybersecurity data for threat management, comprising
receiving a first cybersecurity signal from a first monitoring system, the first monitoring system configured to monitor a computing environment for a cybersecurity threat;
receiving a second cybersecurity signal from a second monitoring system, the second monitoring system configured to monitor the computing environment for the cybersecurity threat, wherein the second monitoring system is independent of the first monitoring system;
generating a unified cybersecurity object based on the first cybersecurity signal and the second cybersecurity signal; and
determining a severity level of the cybersecurity threat based on the unified cybersecurity object.

2. The method of claim 1, further comprising:
generating an instruction for the first monitoring system to scan the computing environment for a second cybersecurity threat, the second cybersecurity threat detected by the second monitoring system.

3. The method of claim 2, further comprising:
generating an instruction for the second monitoring system to scan the computing environment for a third cybersecurity threat, the third cybersecurity threat detected by the first monitoring system.

4. The method of claim 1, further comprising:
generating the unified cybersecurity object further based on metadata received from the first cybersecurity signal and the second cybersecurity signal.

5. The method of claim 1, further comprising:
continuously receiving the first cybersecurity signal and the second cybersecurity signal.

6. The method of claim 1, further comprising:
determining that the cybersecurity threat is present on a cloud entity, wherein the cloud entity is represented by the unified cybersecurity object.

7. The method of claim 1, further comprising:
storing the generated unified cybersecurity object on a graph database, the graph database including a representation of the computing environment.

8. The method of claim 7, further comprising:
generating the representation of the computing environment based on the first cybersecurity signal and the second cybersecurity signal.

9. The method of claim 1, wherein the cybersecurity threat is any one of: a misconfiguration, a malware code, a weak password, an outdated certificate, an exposure, a vulnerability, and any combination thereof.

10. A non-transitory computer readable medium having stored thereon instructions for causing a processing circuitry to execute a process, the process comprising:
receiving a first cybersecurity signal from a first monitoring system, the first monitoring system configured to monitor a computing environment for a cybersecurity threat;
receiving a second cybersecurity signal from a second monitoring system, the second monitoring system configured to monitor the computing environment for the cybersecurity threat, wherein the second monitoring system is independent of the first monitoring system;
generating a unified cybersecurity object based on the first cybersecurity signal and the second cybersecurity signal; and
determining a severity level of the cybersecurity threat based on the unified cybersecurity object.

11. A system for unifying cybersecurity data for threat management, comprising:
a processing circuitry; and
a memory, the memory containing instructions that, when executed by the processing circuitry, configure the system to:
receive a first cybersecurity signal from a first monitoring system, the first monitoring system configured to monitor a computing environment for a cybersecurity threat;
receive a second cybersecurity signal from a second monitoring system, the second monitoring system configured to monitor the computing environment for the cybersecurity threat, wherein the second monitoring system is independent of the first monitoring system;
generate a unified cybersecurity object based on the first cybersecurity signal and the second cybersecurity signal; and
determine a severity level of the cybersecurity threat based on the unified cybersecurity object.

12. The system of claim 11, wherein the memory contains further instructions which, when executed by the processing circuitry, further configure the system to:
generate an instruction for the first monitoring system to scan the computing environment for a second cybersecurity threat, the second cybersecurity threat detected by the second monitoring system.

13. The system of claim 12, wherein the memory contains further instructions which, when executed by the processing circuitry, further configure the system to:
generate an instruction for the second monitoring system to scan the computing environment for a third cybersecurity threat, the third cybersecurity threat detected by the first monitoring system.

14. The system of claim 11, wherein the memory contains further instructions which, when executed by the processing circuitry, further configure the system to:
generate the unified cybersecurity object further based on metadata received from the first cybersecurity signal and the second cybersecurity signal.

15. The system of claim 11, wherein the memory contains further instructions which, when executed by the processing circuitry, further configure the system to:
continuously receive the first cybersecurity signal and the second cybersecurity signal.

16. The system of claim 11, wherein the memory contains further instructions which, when executed by the processing circuitry, further configure the system to:
determine that the cybersecurity threat is present on a cloud entity, wherein the cloud entity is represented by the unified cybersecurity object.

17. The system of claim 11, wherein the memory contains further instructions which, when executed by the processing circuitry, further configure the system to:
store the generated unified cybersecurity object on a graph database, the graph database including a representation of the computing environment.

18. The system of claim 17, wherein the memory contains further instructions which, when executed by the processing circuitry, further configure the system to:
generate the representation of the computing environment based on the first cybersecurity signal and the second cybersecurity signal.

19. The system of claim 11, wherein the cybersecurity threat is any one of: a misconfiguration, a malware code, a weak password, an outdated certificate, an exposure, a vulnerability, and any combination thereof.
